(19) United States
(12) Patent Application Publication
(10) Pub. No.: US 2019/0359026 A1
(43) Pub. Date: Nov. 28, 2019

(54) HVAC SYSTEM WITH PULL-THROUGH CONFIGURATION

(71) Applicant: Calsonic Kansei North America, Inc., Farmington Hills, MI (US)

(72) Inventors: Silvia Denisse Vazquez Salazar, Farmington Hills, MI (US); Christopher Lynn Dawson, Farmington Hills, MI (US)

(21) Appl. No.: 15/986,400

(22) Filed: May 22, 2018

(51) Int. Cl. B60H 1/00; B60H 1/22; B60H 1/32

(52) U.S. Cl. CPC B60H 1/00028; B60H 1/2225; B60H 2001/00128; B60H 1/00064; B60H 2001/006; B60H 1/3233

(57) ABSTRACT

An HVAC system for a vehicle includes an evaporator including a lower end and an opposing upper end, a blower downstream from the evaporator, and a heater downstream from the evaporator, the heater including a lower end that is disposed above the lower end of the evaporator.

### BACKGROUND

The present application relates generally to the field of heating, ventilation, and air conditioning (“HVAC”) systems for vehicles.

In a conventional HVAC system, an inlet opening is defined at an upstream end of the system. A blower is positioned directly at the inlet opening and draws air into the system. A heater and an evaporator are positioned further downstream from the blower for heating and cooling the air in the system, respectively. The placement of both the evaporator and the heater downstream from the blower positions the evaporator and heater closer together. As air passes through the evaporator, condensation forms and may pass to the heater. This condensation can cause damage to heater coils in the heater, reducing the operational life of the heater.

Further, in the conventional HVAC system, the blower draws air through the inlet opening from the surrounding environment. This air is received in the blower in a substantially turbulent flow. For example, the air streams at the inlet opening curve around the inlet opening and generate vortices in the blower disposed directly at the inlet opening. Turbulent streams generate more noise than laminar streams and reduce overall efficiency in the blower relative to laminar streams.

It would therefore be advantageous to provide an HVAC system with a blower positioned downstream from the inlet opening and between the evaporator and the heater in order to protect the heater from condensation from the evaporator. It would further be advantageous to position the blower downstream from the evaporator in order to provide a more laminar flow to the blower and thereby decrease noise from operating the system.

### SUMMARY

One embodiment relates to an HVAC system for a vehicle, including an evaporator including a lower end and an opposing upper end, a blower downstream from the evaporator, and a heater downstream from the evaporator, the heater including a lower end that is disposed above the lower end of the evaporator.

Another embodiment relates to an HVAC system for a vehicle, including a shell having an evaporator housing, a blower housing, and a heater housing. The system further includes an evaporator disposed in the evaporator housing, the evaporator including a lower end and an opposing upper end. The system further includes a blower disposed in the blower housing downstream from the evaporator. The system further includes a heater disposed in the heater housing downstream from the evaporator and the blower, the heater including a lower end disposed above the lower end of the evaporator.

Another embodiment relates to a method of operating an HVAC system for a vehicle, including providing ambient air to an evaporator and outputting a stream from the evaporator in an upward direction toward a blower. The method further includes feeding the stream from the evaporator to the blower and outputting a stream from the blower. The method further includes feeding at least a portion of the stream from the blower to a heater.

### BRIEF DESCRIPTION OF THE DRAWINGS

FIG. 1 is a side cross-sectional view of an HVAC system according to an exemplary embodiment.

FIG. 2 is a side cross-sectional view of a heater portion of an HVAC system in a mixing configuration according to an exemplary embodiment.

FIG. 3 is the heater portion of FIG. 2 in a full-hot configuration.

FIG. 4 is the heater portion of FIG. 2 in a full-cold configuration.

FIG. 5 is a cross-sectional view of the system of FIG. 1, taken across line 5-5.

### DETAILED DESCRIPTION

Referring to the FIGURES generally, an HVAC system is shown according to various exemplary embodiments. The HVAC system includes an evaporator, a blower downstream from the evaporator, and a heater downstream from the blower and the evaporator. In this configuration, the HVAC system is a pull-through system, such that the blower pulls air from the evaporator into a blower inlet, rather than pushing air from a blower outlet through an evaporator downstream from the blower.

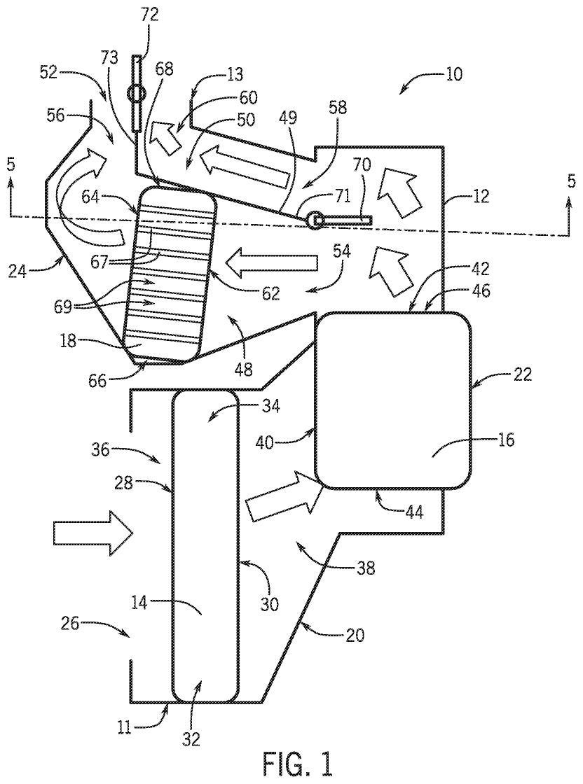

Referring now to FIG. 1, the HVAC system 10 is shown according to an exemplary embodiment. The system 10 includes a shell 12 that houses an evaporator 14, a blower 16, and a heater 18 therein. The shell 12 includes an evaporator housing 20 (i.e., an evaporator portion) substantially surrounding the evaporator 14, a blower housing 22 (i.e., a blower portion) substantially surrounding the blower 16, and a heater housing 24 (i.e., a heater portion) substantially surrounding the heater 18. The evaporator housing 20, blower housing 22, and heater housing 24 may be integrally formed or may be formed as separate structures that are coupled together to form the system 10.

The shell 12 defines a lower end 11 and an opposing upper end 13. The system 10 is configured to be positioned in a vehicle in a substantially vertical orientation, such that the upper end 13 is disposed above (e.g., directly above) the lower end 11. As discussed herein, the terms “above” and “below” or “higher than” and “lower than” may be defined relative to the lower end 11 of the shell 12. In this configuration, the lower end 11 is disposed closest to the ground when the system 10 is installed in a vehicle and the terms “above” and “higher than” indicate that the described portions of the system 10 are disposed further away from the ground than the lower end 11 of the shell 12.

As shown in FIG. 1, an inlet opening 26 is defined at an upstream end of the shell 12, proximate the lower end 11, and is configured to receive air therethrough from ambient air surrounding the system 10 or another supply of air for passing downstream through the system 10. Specifically, the inlet opening 26 is defined at an upstream end of the evaporator housing 20. In this orientation, air passes downstream through the shell 12 from the lower end 11 to the upper end 13 in a generally vertically upward direction (e.g., upward and away from the ground).

The evaporator 14 includes an evaporator inlet 28 configured to receive the air from the inlet opening 26 and an evaporator outlet 30 configured to output cooled air from the evaporator 14 to the blower 16. For example, during operation of the system 10, ambient air is supplied to the evaporator housing 20 through the inlet opening 26. Refrigerant flows between a condenser (not shown) and the evaporator 14. As the ambient air passes through the evaporator 14, heat from the air is transferred through the evaporator 14 to the refrigerant, thereby lowering the temperature of the air in the evaporator housing 20 (e.g., cooling the air) and providing lower temperature air to the blower 16 and the heater 18. In a heating or other configuration, the condenser and/or the evaporator 14 may be switched to an “off” configuration, such that air passes through the evaporator 14 without transferring heat. In this configuration, the air is supplied downstream to the heater 18 at an ambient temperature of the air received at the inlet opening 26.

The evaporator 14 includes a lower end 32 and an opposing upper end 34 disposed above the lower end 32. For example, the evaporator 14 may be oriented in a vertical direction, such that the upper end 34 is disposed directly above the lower end 32 (e.g., perpendicular to the ground) when the system 10 is installed in a vehicle. When the evaporator 14 is installed in the evaporator housing 20, the lower and upper ends 32, 34 engage the evaporator housing 20 or a feature extending therefrom. For example, the lower end 32 of the evaporator housing 20 may engage the lower end 11 of the shell 12. Similarly, lateral sides (e.g., the outermost lateral surfaces) of the evaporator 14 extending between the lower and upper ends 32, 34 of the evaporator 14 engage corresponding lateral sides of the evaporator housing 20 or features extending therefrom. The evaporator 14 may fully engage the evaporator housing 20, such that there are no gaps between the evaporator 14 and the evaporator housing 20. In this configuration, air is prevented from passing between the evaporator 14 and the evaporator housing 20 and substantially all of the air received at the inlet opening 26 passes through the evaporator 14. It should be understood that the ambient air may be received at the inlet opening with a substantially turbulent flow. For example, when a vehicle is moving, interaction of the vehicle with the surrounding air may disrupt the air proximate the system 10 and more specifically, proximate the inlet opening 26. Furthermore, in a configuration in which the inlet opening 26 defines a cross-sectional area that is less than a cross-sectional area of the evaporator housing 20 immediately downstream from the inlet opening 26, sudden expansion of the air generates vortices in the stream, increasing turbulence in the flow.

The evaporator 14 includes a plurality of evaporator coils (not shown), which define a plurality of channels (not shown) extending from the evaporator inlet 28 to the evaporator outlet 30. The plurality of channels restrict rotation of the air in the evaporator 14, thereby decreasing turbulence in the stream and outputting a substantially laminar flow from the evaporator outlet 30.

According to the exemplary embodiment shown in FIG. 1, the evaporator 14 is spaced apart from the inlet opening 26 and the evaporator housing 20 defines an upstream (i.e., first) portion 36 between the inlet opening 26 and the evaporator inlet 28, and a downstream (i.e., second) portion 38 between the evaporator outlet 30 and the blower housing 22. The upstream and downstream portions 36, 38 act as ducts, which guide the air in the evaporator housing 20 into a more laminar flow. For example, the downstream portion 38 decreases in cross-sectional area moving downstream away from the evaporator outlet 30 and toward the blower 16. In this configuration, the downstream portion 38 may act as a baffle, condensing the stream and reducing vortices and turbulence in the stream.

Referring still to FIG. 1, the blower 16 is shown disposed in the blower housing 22. The blower 16 includes a blower inlet 40 configured to receive the air that is output from the evaporator outlet 30 and a blower outlet 42 configured to output air from the blower. According to an exemplary embodiment, substantially all of the air that is output from the evaporator 14 is passed through the blower 16 to the heater 18, as will be discussed in further detail below. The blower 16 further includes a lower end 44 and an opposing upper end 46 disposed above the lower end 44. For example, the blower 16 may be oriented in a vertical direction, such that the upper end 46 is disposed directly above the lower end 44 (e.g., perpendicular to the ground) when the system 10 is installed in a vehicle. Operational noise of the blower 16 may correspond to the amount of turbulence in the flow received at the blower inlet 40. For example, as turbulence of the stream in the blower 16 increases, operational noise of the blower 16 also increases. In contrast, as the stream becomes more laminar, the operational noise of the blower 16 decreases. It should be understood that the position of the blower 16 downstream from the evaporator 14 and the evaporator housing 20 reduces or eliminates turbulence in the stream received at the blower inlet 40 relative to the stream at the inlet opening 26. As a result, the blower 16 generates less noise when compared to a configuration in which the blower 16 is positioned directly at the inlet opening 26. Because the air received at the blower inlet 40 is more laminar, the blower 16 does not have to overcome energy losses due to turbulent flow causing stagnation points. As a result of this laminar flow, the blower 16 further operates more efficiently and wear is reduced, extending the service life of the blower 16.

As shown in FIG. 1, the blower 16 is disposed in the shell 12 above (e.g., higher than) the evaporator 14. For example, the lower end 44 of the blower 16, and therefore the blower inlet 40, are disposed above (e.g., higher than) the lower end 32 of the evaporator 14. In this configuration, the lower end 44 of the blower 16 is disposed a first distance from the lower end 11 of the shell 12 and the lower end 32 of the evaporator 14 is disposed a second distance from the lower end 11 of the shell, which is less than the first distance.

As the evaporator 14 cools air passing therethrough, condensation forms in the stream. Due to gravity, the condensation falls from the evaporator 14 toward the lower end 11 of the shell 12 where it is collected and may be output from the system 10 via an outlet (not shown) or other structure. As shown in FIG. 1, the downstream portion 38 of the evaporator housing 20 extends upward on an angle from (e.g., proximate) the evaporator 14. This upward direction of the downstream portion 38 of the evaporator housing 20 is counteracted by gravity to prevent (i.e., inhibit) condensation formed in the evaporator 14 from traveling downstream in the system 10 from the evaporator 14 toward the blower 16. It should be understood that the position of the lower end 44 of the blower 16 above the lower end 32 of the evaporator 14 reduces or eliminates condensation from being received in the blower 16 and output to the heater 18.

Referring still to FIG. 1, the heater housing 24 includes a heater (e.g., lower, first, etc.) passage 48 and a bypass (e.g., second, upper, etc.) passage 50. The heater 18 is disposed in the heater housing 24 and more specifically in the heater passage 48. The shell 12 includes an outlet opening 52 defined at a downstream end of the shell 12, proximate the upper end 13, and is configured to output air therethrough to ducts and corresponding vents in a passenger compartment of the vehicle. Specifically, the outlet opening 52 is located at a downstream end of the heater housing 24. The heater passage 48 and the bypass passage 50 are formed and fluidly separated by a divider 49 (i.e., a partition) disposed therebetween. The heater passage 48 defines a heater passage inlet 54 (i.e., heater passage opening) at an upstream end of the heater passage 48 and a heater passage outlet 56 at a downstream end of the heater passage 48, opposing the heater passage inlet 54. For example, the heater passage outlet 56 may be disposed proximate the outlet opening 52. Similarly, the bypass passage 50 defines a bypass passage inlet 58 (i.e., bypass passage opening) at an upstream end of the bypass passage 50 and a bypass passage outlet 60 at a downstream end of the bypass passage 50, opposing the bypass passage inlet 58. For example, the bypass passage outlet 60 may be disposed proximate the outlet opening 52 and the heater passage outlet 56.

The heater 18 includes a heater inlet 62 configured to receive at least a portion of the air that is output from the blower outlet 42 and a heater outlet 64 configured to output air from the heater 18. For example, the stream of air that is output from the blower 16 may be split or divided into separate streams flowing through each of the heater passage 48 and the bypass passage 50. The heater passage 48 defines a heater stream passing therethrough and the bypass passage 50 defines a bypass stream passing therethrough. In this configuration, substantially all of the air in the heater stream is passed through the heater 18. According to other exemplary embodiment, in certain operating conditions the heater housing 24 may include only one of the heater stream or the bypass stream, as will be discussed in further detail below.

Referring still to FIG. 1, the heater 18 further includes a lower end 66 and an opposing upper end 68 disposed above the lower end 66. For example, the heater 18 may be oriented in a vertical direction, such that the upper end 68 is disposed directly above the lower end 66 (e.g., perpendicular to the ground) when the system 10 is installed in a vehicle.

According to an exemplary embodiment, the heater 18 is a Positive Temperature Coefficient (“PTC”) heater, which converts electricity into heat. For example, the heater 18 is electrically connected to an electrical source to generate heat rather than drawing heat from an internal combustion engine. In this configuration, the system 10 may be installed in a battery-powered electric vehicle that does not include an internal combustion engine. While the system 10 may be well suited for a battery-powered vehicle, it should be understood that the system 10 may further be used in a vehicle with an internal combustion engine or other power plant. The PTC heater 18 includes a plurality of electric coils 67, which conduct electricity and generate heat. Each of the coils 67 may be operated at different temperatures, such that different portions of the heater stream may be heated to different temperatures based on which coil the portion is passing proximate. For example, a column of coils 67 (e.g., extending from the lower end 66 to the upper end 68 of the heater 18) may be operated at the same temperature as each other but at a different temperature than an adjacent column of coils 67. The heater 18 further includes a plurality of heater channels 69 formed between the coils 67 and extending from the heater inlet 62 to the heater outlet 64. As the heater stream passes through the channels 69 and past the coils 67, heat is transferred from the coils 67 to the heater stream, increasing the temperature of the heater stream between the heater inlet 62 and the heater outlet 64. It should be understood that while FIG. 1 shows the heater 18 as a PTC heater, the heater 18 may be another type of heater, positioned downstream from the evaporator 14 and the blower 16. For example, the heater 18 may receive heat from an internal combustion engine or other heat source or may generate heat in other ways.

As shown in FIG. 1, the heater 18 is disposed in the shell 12 above (e.g., higher than) both the evaporator 14 and the blower 16. According to one exemplary embodiment, the heater 18 may be disposed directly above the evaporator 14, although the heater 18 may be disposed in different locations relative to the evaporator 14 according to other exemplary embodiments. For example, an axis extending substantially perpendicular to the ground may pass through each of the evaporator 14 and the heater 18. The lower end 66 of the heater 18 is disposed above (e.g., higher than) the entire evaporator 14 and above the lower end 44 of the blower 16. In this configuration, the lower end 66 of the heater 18 is disposed a first distance from the lower end 11 of the shell 12 and the lower end 32 of the evaporator 14 is disposed a second distance from the lower end 11 of the shell, which is less than the first distance. Because at least the lower end 66 of the heater 18 is disposed above the lower end 32 of the evaporator 14, gravity prevents the condensation forming in the lower end 11 of the shell 12 from passing to the heater passage 48 and contacting the coils of the heater 18. Specifically, a PTC heater may be very sensitive to moisture and water contacting the coils may damage the heater 18.

It should be understood that with at least a portion of the blower 16 above the evaporator 14 and at least a portion of the heater 18 above the evaporator 14 and/or the blower 16, the system 10 extends substantially vertically in the vehicle. For example, this vertical configuration may reduce an overall width of the system 10. The narrower configuration reduces the overall footprint in the vehicle required for installing the system 10 therein. According to an exemplary embodiment, the system 10 may be installed in a rear portion of the vehicle. For example, the system 10 may be installed in a rear wheel well or other portion of the vehicle, such that the system 10 is installed rearward of the front seats and closer to the rear passenger seats than with a conventional system 10 installed in an engine compartment of the vehicle.

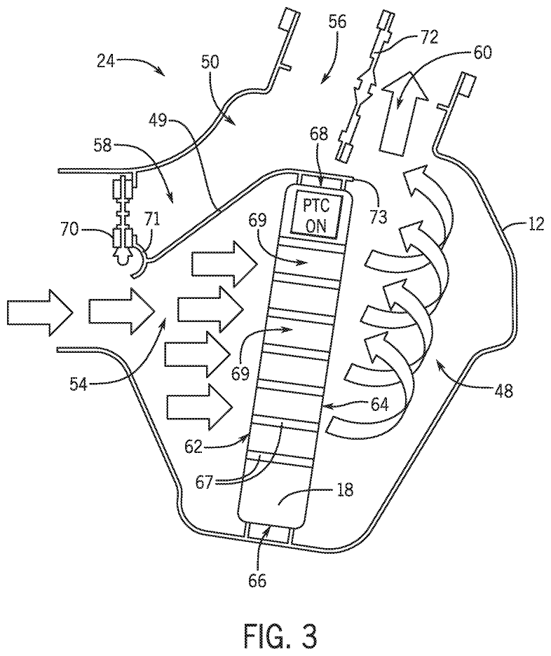

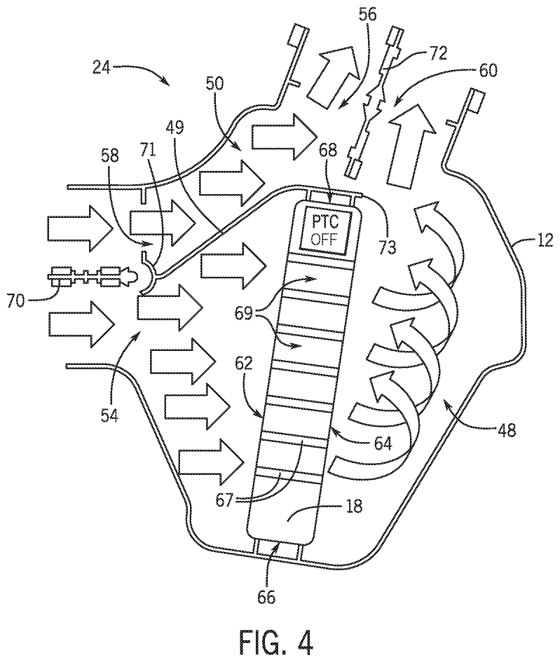

The system 10 includes a mixing door 70 at an upstream end 71 of the divider 49 configured to rotate between a full-hot configuration (e.g., as shown in FIG. 3) and a full-cold configuration (e.g., as shown in FIG. 4) in order to control a volume flow rate of air in the heater passage 48 and/or the bypass passage 50. The system 10 further includes a mode door 72 proximate the outlet opening 52 and configured to rotate between first and second positions. For example, the first position may be a fully-open position, such that air passes out the outlet opening 52 from one or both of the heater passage 48 or the bypass passage 50 unrestricted. The second position may be a fully-closed position, such that the mode door 72 completely closes the outlet opening 52 and prevents any air from being output from the shell 12 into the passenger compartment in the vehicle. The mode door 72 may rotate between the first and second positions to control a volume flow rate of air output from the shell 12. For example, as the mode door 72 rotates toward the second position, the volume flow rate through the outlet opening 52 decreases, thereby decreasing the air output from the system 10. According to another exemplary embodiment, the mode door 72 may be configured to direct air to different portions of the passenger compartment. For example, the first position may be configured to direct a mixture of air output from the heater housing 24 to one of an upper vent (e.g., proximate a user's face and/or hands), a lower vent (e.g., in a foot well), or a defroster (e.g., proximate a windshield). The second position may be configured to direct the mixture of air from the heater housing 24 to another one of the upper vent, lower vent, or defroster. When the system 10 is installed for use with rear passengers in the vehicle (e.g., behind the first row), the mode door 72 may direct the mixture to one of the upper vent or the lower vent, but not to the defroster. According to other exemplary embodiments, the system 10 may be disposed in other areas of the vehicle. For example, the system 10 may be disposed in a forward portion of the vehicle, such as in the an engine compartment.

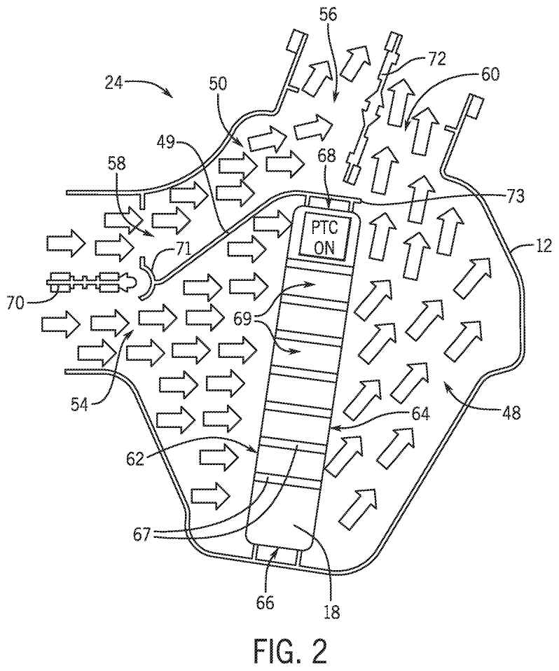

Referring to FIGS. 2-4 generally, the heater housing 24 is shown in various configurations. The heater housing 24 is shown in a reversed orientation than as shown in FIG. 1 and it should be understood that the heater housing 24 may be reoriented relative to the evaporator 14 and the blower 16 according to other exemplary embodiments. Referring now to FIG. 2, the heater housing 24 is shown in a mixing (e.g., a first) configuration. Specifically, the mixing door 70 is shown in a first (e.g., a mixing, open, etc.) orientation. As shown in FIG. 2, the mixing door 70 extends from the upstream end 71 of the divider 49, substantially aligned with the divider 49. In this orientation, the mixing door 70 does not inhibit air from passing through the heater passage 48 or the bypass passage 50. The volume flow rate of the heater stream and the bypass stream may be determined based on a cross-sectional area of the heater passage inlet 54 relative to a cross-sectional area of the bypass passage inlet 58. For example, if the cross-sectional area of the heater passage inlet 54 is substantially the same as the cross-sectional area of the bypass passage inlet 58, the heater stream and the bypass stream may have substantially the same volume flow rate in the system 10. In the configuration shown in FIG. 2, the mixing door 70 is in a 50/50 configuration, such that approximately half of the stream output from the blower 16 is directed to the heater passage 48 as part of the heater stream and the remainder (e.g., approximately half) of the stream output from the blower 16 is directed to the bypass passage 50 as part of the bypass stream.

In the mixing configuration, the heater 18 is in an “on” configuration for heating the heater stream (shown in FIG. 2 with the “PTC ON” designation). The bypass stream maintains a substantially constant temperature in the bypass passage 50 based on the temperature of the air output from the evaporator 14 and the blower 16. However, the heater stream is heated in the heater 18 and output from the heater passage 48 at a higher temperature than the bypass stream. The heater stream and bypass stream are then mixed proximate the outlet opening 52 to provide an outlet stream that is output from the system 10 into the vehicle at a temperature greater than the temperature of the bypass stream and less than the temperature of the heater stream. It should be understood that the heater stream and the bypass stream may be mixed upstream from the outlet opening 52 and/or the mode door 72 or, according to another exemplary embodiment, the heater stream and the bypass stream may be mixed downstream from the outlet opening 52 in a duct for passing the mixed air to the passenger compartment of the vehicle.

Referring now to FIG. 3, the heater housing 24 is shown in a full-hot (i.e., a second) configuration. Specifically, the mixing door 70 is shown in a second (i.e., a full-hot, closed, etc.) orientation. The mixing door 70 is pivoted from its position in FIG. 2 and extends from the upstream end 71 of the divider 49, substantially perpendicularly to the divider 49. In this orientation, the mixing door 70 covers the bypass passage inlet 58 and inhibits any air from passing into the bypass passage 50. In this configuration, substantially the entire stream that is output from the blower 16 is passed through the heater passage 48 as part of the heater stream, such that no bypass stream is present in the bypass passage 50. The volume flow rate of the heater stream is substantially the same as the volume flow rate of the stream output from the blower 16.

In the full-hot configuration, the heater 18 is in the “on” configuration for heating the heater stream (as indicated by the “PTC ON” designation in FIG. 3). Because there is no bypass stream, all of the air output from the system 10 is heated in the heater passage 48, providing air at the hottest temperature the heater 18 is capable of producing or at any temperature provided by the heater 18 regardless of the ambient air temperature outside the system 10. According to another exemplary embodiment, the heater 18 may be controlled by a controller to generate less than the maximum amount of heat the heater 18 is capable of producing. For example, the coils 67 may cycle on and off to provide the heater stream at an average temperature that is less than the maximum capable temperature of the heater 18.

While FIGS. 2 and 3 show the mixing door 70 in either a fully open or fully closed orientation, it should be understood that the mixing door 70 may be positioned in other orientations. For example, the mixing door 70 may be positioned partway (e.g., halfway) between the first orientation and the second orientation. In this configuration, the mixing door 70 partially covers (i.e., obscures, interferes with, etc.) the bypass passage inlet 58, restricting the volume flow rate of air entering the bypass passage 50. As the mixing door 70 moves from the first orientation toward the second orientation, the cross-sectional area at the bypass passage inlet 58 decreases, thereby reducing the volume flow rate of the bypass stream. As the volume flow rate of the bypass stream decreases, the volume flow rate of the heater stream increases, thereby increasing the ratio of heater stream to bypass stream at the outlet opening 52 and the temperature of the air output from the system 10.

Referring now to FIG. 4, the heater housing 24 is shown in a full-cold (i.e., a third) configuration. In this configuration, the mixing door 70 is provided in the first orientation or position. In the full-cold configuration, the evaporator 14 is in the “on” configuration to cool the air in the system 10 and the heater 18 is in the “off” configuration (as indicated by the “PTC OFF” designation in FIG. 4), such that the heater stream is not heated by the heater 18. Because the heater 18 is not operating, the heater stream and the bypass stream maintain the same cold temperature as the stream output from the evaporator 14. Specifically, the heater stream and the bypass stream are each provided to and output from the outlet opening 52 at substantially the same temperature. It should further be understood that when the mixing door 70 is provided in the first orientation, the evaporator 14 is in the “off” configuration, and the heater 18 is in the “off” configuration, air is output from the outlet opening 52 at a temperature substantially the same as the ambient temperature of the air when it is first received at the inlet opening 26 of the system 10.

While FIGS. 2 and 3 show the second position covering only the bypass passage inlet 58, it should be understood that according to other exemplary embodiments, one or more mixing doors 70 may cover at least a portion of the heater passage inlet 54 instead of or in addition to covering the bypass passage inlet 58. In this configuration, air that is output from the blower 16 may bypass the heater 18 and pass through the bypass passage 50. For example, when the temperature in the passenger compartment is being changed quickly from a heating configuration to a cooling configuration, the mixing door 70 may cover the heater passage inlet 54, causing substantially all of the air to be directed through the bypass passage 50 until the heater 18 cools down and prevent the heater 18 from inadvertently heating a portion of the stream. Once the heater 18 is cooled, the mixing door 70 may return to the first position (e.g., as shown in FIG. 4) and allow cooled air from the evaporator 14 to pass through both of the heater passage 48 and the bypass passage 50 without heating either of the heater stream or the bypass stream.

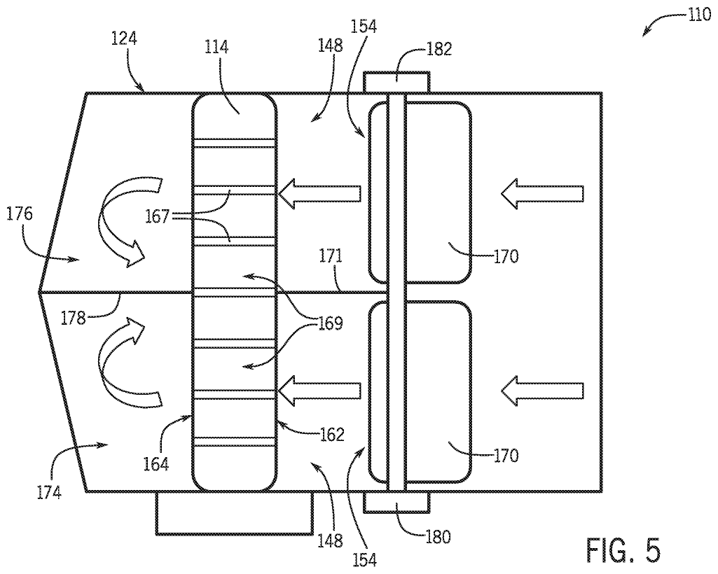

Referring now to FIG. 5, a system 110 is shown according to another exemplary embodiment. It should be noted that the system 110 is similar to the system 10 shown in FIGS. 1-4 and like reference numerals refer to like elements. As provided in FIG. 5, a cross-sectional view of the heater housing 124 shows the system 110 as a multi-zone system configured to provide air to different portions of the passenger compartment at different temperatures. The heater housing 124 may be subdivided into a plurality of adjacent compartments corresponding to separate zones in the vehicle. For example, the heater housing 124 includes a first compartment 174 (i.e., a first conduit) corresponding to a first zone and a second compartment 176 (i.e., a second conduit) corresponding to a second zone and configured to provide air to different portions of the passenger compartment at two different temperatures. Specifically, the first compartment 174 outputs a first stream from the outlet opening 152 having a first temperature and the second compartment 176 outputs a second stream from the outlet opening 152 fluidly separate from and at a different temperature than the first stream. A partition wall 178 extends downstream from the upstream end 171 of the divider 149 to the outlet openings 152, separating the first and second compartments 174, 176 and keeps the streams in the first compartment 174 and the second compartment 176 fluidly separated from each other downstream from the mixing doors 170. While FIG. 5 shows the heater housing 124 having two compartments 174, 176, it should be understood that the system 110 may include more than two zones and that a separate compartment may be provided for each zone. An additional partition wall 178 may be included to fluidly separate each additional compartment in substantially the same way as the partition wall 178 discussed above.

As shown in FIG. 5, each compartment 174, 176 may include a mixing door 170 and a portion of the heater 118, which is individually controllable to set the temperature in the given compartment 174, 176. For example, the first compartment 174 may include a first mixing door 170 and define a first heater passage 148 and a first bypass passage 150. Similarly, the second compartment 176 may include a second mixing door 170 and define a second heater passage 148 and a second bypass passage 150. The first and second mixing doors 170 may be separately articulated (i.e., controlled). Specifically, as shown in FIG. 5, the system 110 includes a first actuator 180 coupled to the first mixing door 170 in the first compartment 174 and a second actuator 182 coupled to the second mixing door 170 in the second compartment 176, which operates independently from the first actuator 180. Each of the first or second mixing doors 170 operate as described above, such that the temperature output from the first and second compartments 174, 176 are separately controlled, as discussed above. For example, the temperature may be controlled by changing the mixing ratio due to the orientation of the mixing doors 170.

According to another exemplary embodiment, different portions or zones of the heater 118 may be heated to different temperatures in each of the compartments 174, 176 to output air at different temperatures. In yet another exemplary embodiment, a portion of the heater 118 may be turned to the “on” configuration in one of the compartments 174, 176, and another portion of the heater 118 may be turned to the “off” configuration in the other one of the compartments 174, 176, such that one of the compartments 174, 176 outputs air at a temperature greater than the ambient temperature and the other compartment 174, 176 outputs air at a temperature that is the same as or less than the ambient temperature.

Each compartment may further include its own separately articulating mode door 172, such that passengers in different zones may receive air at different vents in the zone. For example, the first compartment 174 includes a first mode door 172 and the second compartment 176 includes a second mode door 172, which is configured to be operated independently from the first mode door 172. According to another exemplary embodiment, the mode doors 172 control a volume flow rate of air output from each compartment 174, 176. In this configuration, the second mode door 172 may be rotated to a different orientation than the first mode door 172, such that air is output from the second compartment 176 at a different volume flow rate than from the first compartment 174 and provide air to the different zones of the passenger compartment at different fan speeds, even though the system 110 includes one blower 116 operating at the same speed for each of the zones. According to another exemplary embodiment, the system 110 may include a single mode door 172 that extends across both the first and second compartments 174, 176 proximate the outlet opening 152. In this configuration, the mode door 172 may provide air to the same vent or combination of vents in each zone of the passenger compartment, even if the temperatures in the zones are different from each other.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. An HVAC system for a vehicle comprising:
an evaporator including a lower end and an opposing upper end;
a blower downstream from the evaporator; and
a heater downstream from the evaporator, the heater including a lower end that is disposed above the lower end of the evaporator.

2. The system of claim 1, wherein the heater is downstream from the blower.

3. The system of claim 2, wherein the blower is configured to receive air from the evaporator and to output air to the heater.

4. The system of claim 1, wherein the lower end of the heater is disposed above the upper end of the evaporator.

5. The system of claim 1, wherein:
the blower includes a lower end and an opposing upper end; and
the lower end of the blower is disposed above the lower end of the evaporator.

6. An HVAC system for a vehicle comprising:
a shell comprising an evaporator housing, a blower housing, and a heater housing;
an evaporator disposed in the evaporator housing, the evaporator including a lower end and an opposing upper end;
a blower disposed in the blower housing downstream from the evaporator; and
a heater disposed in the heater housing downstream from the evaporator and the blower, the heater including a lower end disposed above the lower end of the evaporator.

7. The system of claim 6, wherein:
the heater housing further comprises a heater passage and a bypass passage fluidly separated by a divider; and
the heater is disposed in the heater passage.

8. The system of claim 7, further comprising a mixing door disposed at an upstream end of the divider, the mixing door configured to control a volume flow rate of air in at least one of the heater passage or the bypass passage.

9. The system of claim 8, wherein the mixing door is configured to rotate between a first orientation substantially aligned with the divider and a second orientation substantially covering a bypass passage inlet.

10. The system of claim 6, further comprising an inlet opening defined at an upstream end of the shell and configured to receive ambient air therethrough in the evaporator housing;
wherein the blower defines a blower inlet and a blower outlet; and
wherein a stream received at the blower inlet from the evaporator housing is less turbulent than a stream proximate the inlet opening.

11. The system of claim 10, wherein the evaporator housing defines a downstream portion between the evaporator and the blower, the downstream portion configured to reduce turbulence in the stream received at the blower inlet.

12. The system of claim 11, wherein the downstream portion defines a cross-sectional area this decreases moving from the evaporator to the blower.

13. The system of claim 11, wherein the downstream portion extends upward on an angle from the evaporator.

14. The system of claim 6, wherein the lower end of the heater is disposed above the upper end of the evaporator.

15. The system of claim 6, wherein:
the blower includes a lower end and an opposing upper end; and
the lower end of the blower is disposed above the lower end of the evaporator.

16. The system of claim 6, wherein:
the blower includes a blower inlet and a blower outlet; and
the blower inlet is disposed above the lower end of the evaporator.

17. A method of operating an HVAC system for a vehicle comprising:
providing ambient air to an evaporator;
outputting a stream from the evaporator in an upward direction toward a blower;
feeding the stream from the evaporator to the blower;
outputting a stream from the blower; and
feeding at least a portion of the stream from the blower to a heater.

18. The method of claim 17, further comprising outputting the stream from the blower in an upward direction toward the heater.

19. The method of claim 17, further comprising:
closing a bypass passage with a mixing door; and
feeding substantially all of the stream from the blower through a heater passage to the heater.

20. The method of claim 17, further comprising:
forming condensation in the evaporator; and
collecting the condensation in an evaporator housing upstream from the blower.
